(19) United States
(12) Patent Application Publication
(10) Pub. No.: US 2014/0326177 A1
(43) Pub. Date: Nov. 6, 2014

(54) MASK AND A METHOD FOR MANUFACTURING THE SAME

(71) Applicant: TGO Tech. Corporation, Hwaseong-si (KR)

(72) Inventors: Dong Jin LEE, Jeonju-si (KR); Yoo Jin LEE, Yongin-si (KR); Jae Hak LEE, Seoul (KR)

(73) Assignee: TGO Tech. Corporation, Hwaseong-si (KR)

(21) Appl. No.: 14/260,595

(22) Filed: Apr. 24, 2014

(30) Foreign Application Priority Data
May 2, 2013 (KR) 10-2013-0049486

(51) Int. Cl. H05B 33/10; B22D 23/04; B22D 25/02

(52) U.S. Cl. CPC H05B 33/10; B22D 25/02; B22D 23/04
USPC 118/504; 164/131

(57) ABSTRACT

A mask and a method for manufacturing the mask are disclosed. The method for manufacturing the mask comprises forming an insulating pattern layer on a substrate, forming a metal plating film on the substrate formed with the insulating pattern layer through a plating process, and separating the metal plating film from the substrate formed with the insulating pattern layer.

### FIELD OF THE INVENTION

The present invention relates to a mask and a method for manufacturing the mask. More particularly, the present invention relates to a mask and a method for manufacturing the mask, which may improve uniformity of an organic electroluminescent unit.

### BACKGROUND OF THE INVENTION

Electroluminescent devices are actively researched among the other flat panel display devices because they may emit various colors of light, may be easily patterned and made into thin films, and have low direct current driving voltage and high luminous efficiency.

In particular, organic electroluminescent devices (OLEDs) do not require a separate light source unlike a conventional thin film transistor liquid crystal display devices (TFT-LCDs), thereby reducing the volume and weight of the devices, and may be driven with a low voltage compared to a plasma display panel (PDP). Due to those advantages, organic electroluminescent devices are expected to be widely used in the future.

In order to form an organic electroluminescent device on a substrate, a method for depositing an organic substance on the substrate using a mask may be utilized. That is, the organic substance may be sprayed through a nozzle toward the substrate, wherein the mask may be disposed between the nozzle and the substrate such that the organic substance may be deposited only on a region where the organic electroluminescent device is to be formed.

FIG. 7 illustrates that an organic electroluminescent device is formed using a conventional mask. Referring to FIG. 7, an organic substance is sprayed from a nozzle 50′, wherein a mask 3 is positioned between the nozzle 50′ and a device formation plate 10′. The mask 3 is formed with an opening 3′ corresponding to a pattern of an organic electroluminescent device 20′ to be formed on the device formation plate 10′. The opening 3′ is formed in a direction perpendicular to a surface of the mask 3. Since the area of the nozzle 50′ is typically larger than that of the opening 3′, there are formed routes in which the organic substance sprayed radially from the nozzle 50′ passes through the opening 3′, as illustrated in FIG. 7 (see dotted lines). That is, in FIG. 7, a2 is the route in which the organic substance sprayed from the left end of the nozzle 50′ passes through the left end of the opening 3′, and b2 is the route in which the organic substance sprayed from the right end of the nozzle 50′ passes through the left end of the opening 3′. Assuming that the organic substance is uniformly sprayed through the entire area of a spray hole of the nozzle 50′, the organic substance passes through the opening 3′ such that the middle portion of the organic electroluminescent device 20′ formed on the device formation plate 10′ has a uniform thickness while the thickness of the organic electroluminescent device 20′ gradually decreases farther from the middle portion. This phenomenon is referred to as a shadow effect. In FIG. 7, p1 indicates the width of the region where the thickness of the organic electroluminescent device 20′ is not uniform due to the shadow effect.

When an organic electroluminescent device is formed using a conventional mask, the area of the region where the thickness of the organic electroluminescent device is not uniform due to the shadow effect is increased, which results in a problem of deterioration in the quality and performance of the organic electroluminescent device.

### SUMMARY OF THE INVENTION

One object of the present invention is to provide a mask and a method for manufacturing the mask, which may improve uniformity of an organic electroluminescent unit.

Another object of the present invention is to provide a method for manufacturing a mask, which may facilitate formation of the mask.

According to one aspect of the present invention to achieve the above-described objects, there is provided a method for manufacturing a mask, comprising: forming an insulating pattern layer on a substrate; forming a metal plating film on the substrate formed with the insulating pattern layer through a plating process; and separating the metal plating film from the substrate formed with the insulating pattern layer.

According to another aspect of the present invention, there is provided a mask comprising a plurality of openings, wherein each of the plurality of openings has a vertical section in the shape of a trapezoid.

In addition, there may be further provided other configurations to implement the present invention.

According to the present invention, there are provided a mask and a method for manufacturing the mask, which may improve uniformity of an organic electroluminescent unit.

Further, there is provided a method for manufacturing a mask, which may facilitate formation of the mask.

### BRIEF DESCRIPTION OF THE DRAWINGS

FIGS. 1, 2A, 2B, 3 and 4 illustrate a method for manufacturing a mask according to one embodiment of the present invention;

FIG. 5 illustrates a mask according to one embodiment of the present invention;

FIG. 6 illustrates that an organic electroluminescent device is formed using a mask according to one embodiment of the present invention; and

FIG. 7 illustrates that an organic electroluminescent device is formed using a conventional mask.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to carry out the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Further, it shall be understood that the locations or arrangements of individual elements within each of the embodiments described herein may also be modified without departing from the spirit and scope of the invention. Accordingly, the following detailed description is not to be taken in a limiting sense, and the scope of the present invention is to be taken as encompassing the scope of the appended claims and all equivalents thereof, as long as properly described. In the drawings, like reference numerals refer to the same or similar functions throughout the several views, and certain features such as length, area, thickness and shape may be exaggerated for convenience.

Hereinafter, various preferred embodiments of the present invention will be described in detail with reference to the accompanying drawings to enable those skilled in the art to easily carry out the invention.

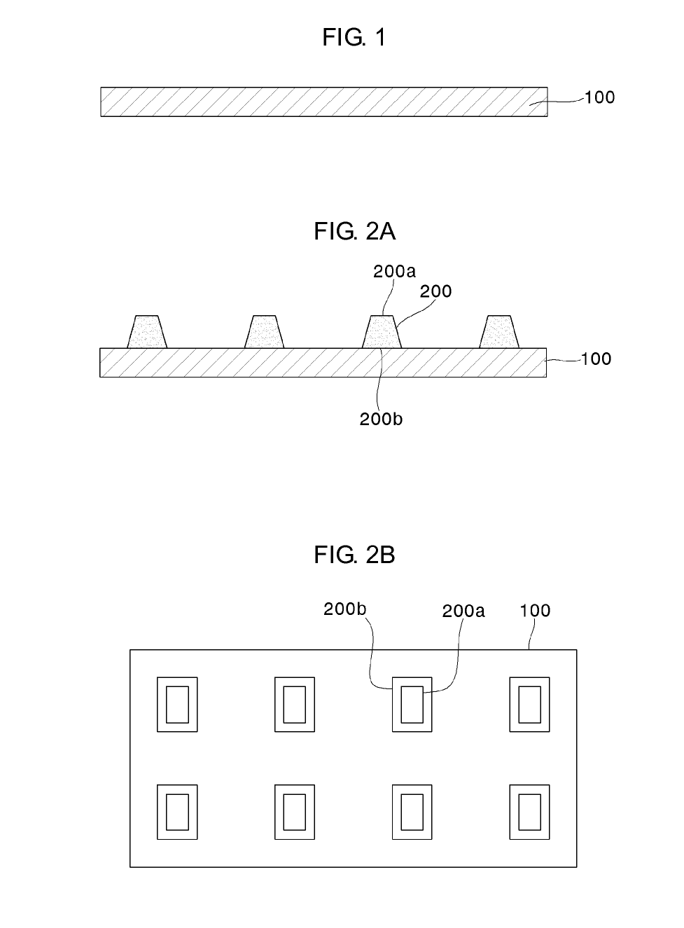

FIGS. 1 to 4 illustrate a method for manufacturing a mask according to one embodiment of the present invention.

Referring to FIG. 1, a substrate 100 may be provided to form a mask. The substrate 100 may be a conductive substrate made of metal or the like, or an insulating substrate made of glass or the like. When the substrate 100 is a conductive substrate, the substrate may be used in a subsequent process as it is. However, when the substrate 100 is an insulating substrate, it is necessary to form a separate conductive layer (not shown) thereon. Since a plating method is employed to form the mask in a subsequent process, it is necessary that at least a part of the substrate 100 is conductive. When the separate conductive layer (not shown) is formed, a deposition process such as a sputtering process may be employed.

Referring to FIG. 2A, an insulating pattern layer 200 may be formed on the substrate 100 using an insulating material. As illustrated in FIG. 2A, the cross section of the insulating pattern layer 200 may be in the shape of a trapezoid, the upper portion 200a of which is narrower than the lower portion 200b. In order to make the cross section of the insulating pattern layer 200 in the shape of a trapezoid, a photolithography process or a method for fine patterning of polymethyl methacrylate (PMMA) may be employed, for example. To describe the photolithography process in more detail, the insulating pattern layer 200 may be formed by applying a photo resist onto the substrate 100 and then adjusting exposure energy used in the photolithography process such that the sides of the remaining portions of the photo resist are inclined. To describe the method for fine patterning of PMMA, the insulating pattern layer 200 may be formed by applying PMMA onto the substrate 100 and then performing an imprinting process such that the sides of the remaining portions of the PMMA are inclined. The shape of the opening formed in a metal plating film to be described later may be determined to correspond to that of the insulating pattern layer 200.

FIG. 2B illustrates that the insulating pattern layer 200 is formed on the substrate 100 of FIG. 2A.

Referring to FIG. 3, a metal plating film 300 may be formed on the substrate where the insulating pattern layer 200 is formed. In order to form the metal plating film 300, an electroplating process may be employed. The material of the metal plating film 300 may be an iron-nickel alloy including Invar (an alloy of 36% Ni and 64% Fe). Since the metal plating film 300 is formed using an electroplating process, the metal plating film may not be formed on the region where the insulating pattern layer 200 is formed. Accordingly, a region corresponding to where the insulating pattern layer 200 is formed may become the opening of the metal plating film 300.

Referring to FIG. 4, the metal plating film 300 may be separated from the substrate 100 where the insulating pattern layer 200 is formed. As described above, the region corresponding to where the insulating pattern layer 200 is formed may become the opening 310, and the vertical section of the opening 310 may be in the shape of a trapezoid such that the area of the lower portion 310b of the opening 310 is larger than that of the upper portion 310a according to the shape of the insulating pattern layer 200.

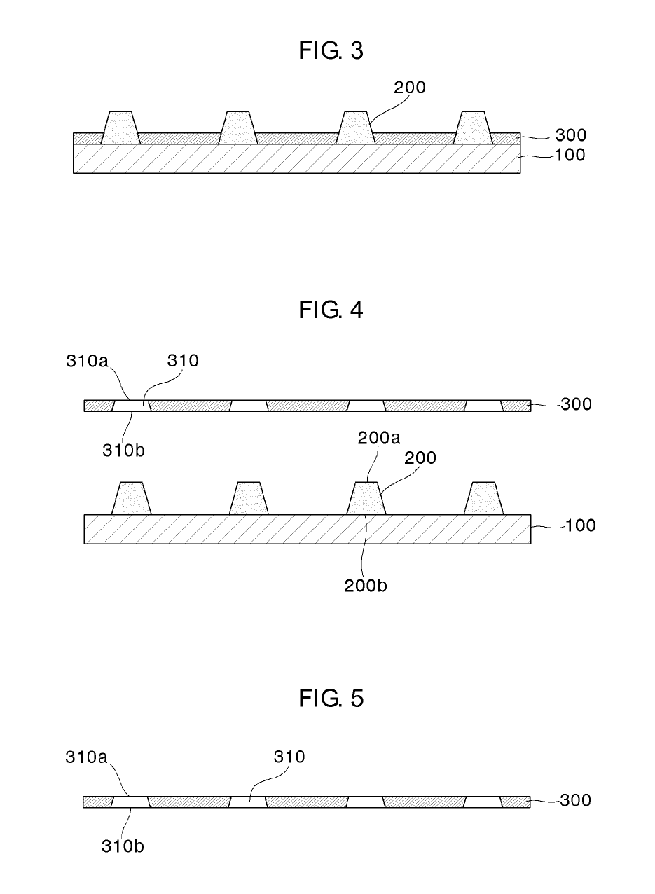

FIG. 5 illustrates a mask according to one embodiment of the present invention. The metal plating film 300 formed according to the above-described embodiment of the invention becomes the mask. Accordingly, hereinafter, reference numeral 300 indicates the mask according to one embodiment of the invention.

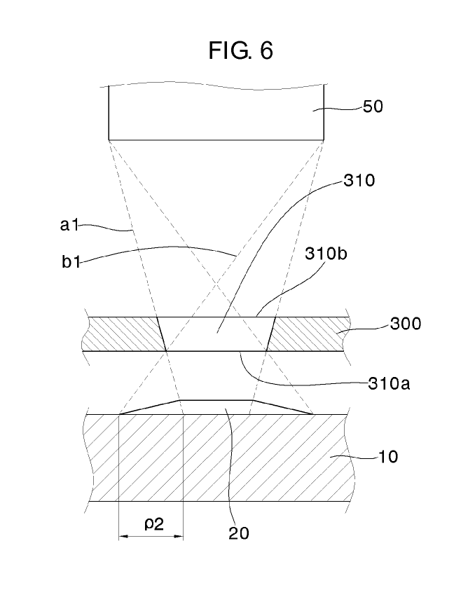

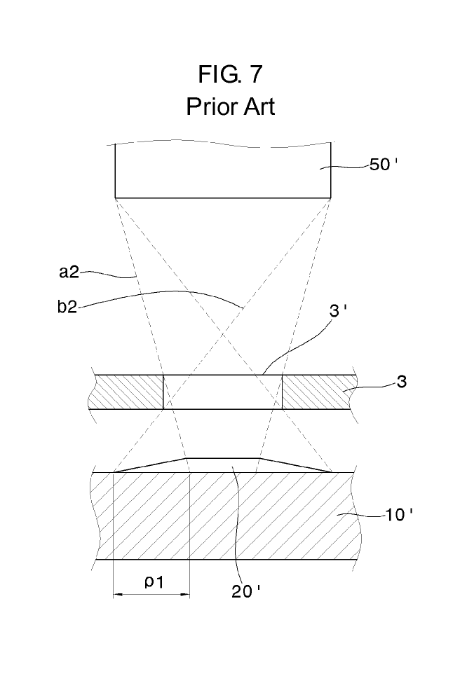

FIG. 6 illustrates that an organic electroluminescent device 20 is formed using a mask according to one embodiment of the present invention. Referring to FIG. 6, an organic substance is sprayed from a nozzle 50, and the mask 300 according to one embodiment of the invention is positioned between the nozzle 50 and a device formation plate 10. The organic electroluminescent device 20 may be formed on the top of the device formation plate 10. The mask 300 is formed with the opening 310, which may correspond to a pattern of the organic electroluminescent device 20 to be formed on the device formation plate 10. As illustrated in FIG. 6, there are formed routes in which the organic substance sprayed radially from the nozzle 50 passes through the opening 310 (see dotted lines). For example, in FIG. 6, a1 is the route in which the organic substance sprayed from the left end of the nozzle 50 passes through the left end of the opening 310, and b1 is the route in which the organic substance sprayed from the right end of the nozzle 50 passes through the left end of the opening 310. As compared to the conventional mask illustrated in FIG. 7, the sides of the opening 310 in the mask 300 according to one embodiment of the invention are inclined such that the route b1 (in which the organic substance sprayed from the right end of the nozzle 50 passes through the left end of the opening 310) crosses the device formation plate 10 at a location closer to the center of the organic electroluminescent device 20 compared to the conventional case. That is, by means of the mask 300 according to one embodiment of the invention, the region where the thickness of the organic electroluminescent device is not uniform due to the shadow effect is reduced compared to the conventional one. Although the foregoing description has been made only on the left outer periphery of the organic electroluminescent device 20 with reference to FIG. 6, the description may be equally applied to the other outer periphery of the organic electroluminescent device 20. In FIG. 6, p2 indicates the width of the region where the thickness of the organic electroluminescent device 20 is not uniform due to the shadow effect, and it can be seen that p2 is narrower than p1 in FIG. 7. Accordingly, the quality and performance of the organic electroluminescent device 20 may be improved.

Although the present invention has illustrated and described as above in connection with the preferred embodiments, the invention is not limited to the above embodiments, and various modifications and changes may be made by those skilled in the art without departing from the spirit and scope of the invention. Such modifications and changes should be considered to fall within the scope of the present invention and the appended claims.

What is claimed is:

1. A method for manufacturing a mask, the method comprising:
forming an insulating pattern layer on a substrate;
forming a metal plating film on the substrate formed with the insulating pattern layer through a plating process; and
separating the metal plating film from the substrate formed with the insulating pattern layer.

2. The method of claim 1, wherein a vertical section of the insulating pattern layer is in the shape of a trapezoid, the upper portion thereof being narrower than the lower portion thereof.

3. The method of claim 1, wherein the metal plating film is made of an iron-nickel alloy.

4. The method of claim 1, wherein the substrate is a conductive substrate.

5. The method of claim 1, wherein the substrate is an insulating substrate on which a conductive layer is formed.

6. The method of claim 1, wherein the insulating pattern layer is formed through a photolithography process.

7. The method of claim 1, wherein the insulating pattern layer is formed of patterned polymethyl methacrylate (PMMA).

8. A mask comprising:
a plurality of openings,
wherein each of the plurality of openings has a vertical section in the shape of a trapezoid.

9. The mask of claim 8, wherein the mask is made of an iron-nickel alloy.

10. A mask manufactured by the mask manufacturing method of claim 1.
